(19) United States
(12) Patent Application Publication
(10) Pub. No.: US 2020/0062453 A1
(43) Pub. Date: Feb. 27, 2020

(54) HOLLOW BODY HAVING A WALL OF GLASS WITH A SURFACE REGION HAVING CONTENTS OF SI AND N

(71) Applicant: Schott AG, Mainz (DE)

(72) Inventors: Eveline Rudigier-Voigt, Mainz (DE); Stephanie Mangold, Schornsheim (DE); Urban Weber, Weiler bei Bingen (DE); Stefan Muth, Ober-Olm (DE); Anna Kathrin Verma, Offenbach (DE); Yakup Gönüllü, Essenheim (DE)

(73) Assignee: Schott AG, Mainz (DE)

(21) Appl. No.: 16/546,979

(22) Filed: Aug. 21, 2019

(30) Foreign Application Priority Data
Aug. 21, 2018 (EP) 18190032.5

(51) Int. Cl. B65D 23/02; B65D 1/02; C03C 3/091; C03C 3/11; A61J 1/06

(52) U.S. Cl. CPC B65D 23/02; B65D 1/0207; A61J 1/065; C03C 3/111; C03C 3/091

(57) ABSTRACT

A hollow body includes a wall of glass which at least partially surrounds an interior volume of the hollow body. The wall of glass has a wall surface which has a surface region. At least in the surface region the wall surface has a content of N in a range from 0.3 to 10.0 at-%, and at least 5 at-% Si.

### BACKGROUND OF THE INVENTION

### 1. Field of the Invention

The present invention relates to hollow bodies and, more particularly, hollow bodies for packaging pharmaceutical compositions. Further, the present invention relates to a process for making an item and a hollow body obtainable thereby; to a closed container; to a process for packaging a pharmaceutical composition; to a closed hollow body obtainable by this process; to a use of a hollow body for packaging a pharmaceutical composition; and to a use of a composition comprising N.

### 2. Description of the Related Art

Containers made from glass have been applied for transporting fluids and powders safely for several centuries. In the last decades, the arts in which glass containers are used for transporting fluids and powders have become increasingly diverse and sophisticated. One such art is the technical field of the present application: pharmaceutical packaging. In the pharmaceutical industry, glass containers—such as vials, syringes, ampules and cartridges—are applied as primary packaging for all kinds of pharmaceutically relevant compositions, in particular drugs, such as vaccines. Specifically in this art, the requirements put on the glass containers have become more and more sophisticated, recently.

Glass containers for pharmaceutical packaging are typically cleaned, sterilized, filled and closed, on an industrial scale in a line of processing, referred to as filling line herein. There is a need to increase a production rate of such a filling line in the art. This may be implemented by increasing a velocity of the filling line and/or by reducing shut down times due to disruptions of the processing. In the prior art, such disruptions are typically caused by the occurrence of breakage of glass containers during processing, in particular due to high transportation velocities on the filling line. If such breakage occurs, production has to be stopped, the line has to be cleaned thoroughly from particles and dust and then the system has to be readjusted before it is started again. Contamination of the glass containers with any kind of pharmaceutically relevant particles, in particular glass particles, or pharmaceutically relevant sub-stances has to be avoided strictly, in particular if parenterals are packaged.

Further, scratching of the glass surfaces of the containers has to be avoided as far as possible. Scratches on the container surface may hamper an optical inspection of the filled containers, in particular for the presence of pharmaceutically relevant particles. Further, scratching can lead to glass particles or dust being disassociated from the containers. These particles and dust may contaminate the containers on the filling line.

In general, attempts to solve the above problems by applying a coating to the container surface are known in the prior art. The requirements on such coatings are rather sophisticated. They have to withstand high temperatures which occur in a sterilization treatment referred to in the art as depyrogenization. Further, the coatings have to withstand low temperature treatments such as freeze drying. Even more, the coatings have to withstand washing processes, which include increased temperatures and mechanical influences. This means that the advantageous properties which the coating provides to the exterior surface of the container have to be maintained and, in addition, contamination of the container interior with any pharmaceutically relevant particle or substance from the coating has to be avoided. The preceding sophisticated requirements have led to the development of rather complex multilayer coatings of the prior art. Such multilayer coatings are typically complex and costly to apply and thus, run contrary to the need for high processing rates.

What is needed in the art is a way to at least partly overcome some of the previously described disadvantages arising from the prior art.

### SUMMARY OF THE INVENTION

Exemplary embodiments disclosed herein provide a hollow body including a wall of glass having a wall surface with a surface region that has a content of N in a range from 0.3 to 10.0 at-% and at least 5 at-% Si, which contents are both determinable by X-ray photoelectron spectroscopy

In some exemplary embodiments provided according to the present invention, a hollow body includes a wall of glass which at least partially surrounds an interior volume of the hollow body. The wall of glass has a wall surface, which comprises a surface region. At least in the surface region, the wall surface has a content of N in a range from 0.3 to 10.0 at-% and at least 5 at-% Si. The preceding contents of N and Si are both determinable by X-ray photoelectron spectroscopy.

Further exemplary embodiments of the hollow body provided according to the present invention are described further herein.

In some embodiments, the content of N may be from 0.35 to 10 at-%, from 0.4 to 10.0 at-%, from 0.45 to 10.0 at-%, from 0.5 to 10.0 at-%, from 0.55 to 10.0 at-%, from 0.6 to 10.0 at-%, from 0.7 to 10.0 at-%, from 0.8 to 10.0 at-%, from 0.9 to 10.0 at-%, from 1.0 to 10.0 at-%, from 1.0 to 9.0 at-%, from 1.0 to 8.0 at-%, 1.0 to 7.0 at-%, from 1.0 to 6.0 at-%, from 1.0 to 5.0 at-%, from 1.0 to 4.0 at-%, from 1.0 to 3.0 at-%, or from 1.0 to 2.0 at-%.

In some embodiments, the wall surface has content of N in a range from 0.3 to 9.0 at-%, such as from 0.3 to 8.0 at-%, from 0.3 to 7.0 at-%, from 0.3 to 6.0 at-%, from 0.3 to 5.0 at-%, from 0.35 to 5.0 at-%, from 0.4 to 5.0 at-%, from 0.45 to 5.0 at-%, from 0.5 to 5.0 at-%, from 0.55 to 5.0 at-%, from 0.6 to 5.0 at-%, from 0.7 to 5.0 at-%, from 0.8 to 5.0 at-%, from 0.9 to 5.0 at-%, from 1.0 to 5.0 at-%, from 1.0 to 4.0 at-%, from 1.0 to 3.0 at-%, or from 1.0 to 2.0 at-%, in each case in the surface region.

In some embodiments, the content of Si is at least 10 at-%, such as at least 11 at-%, at least 12 at-%, at least 13 at-%, or at least 14 at-%,

In some embodiments, the content of Si of the wall surface in the surface region is in a range from 5 to 50 at-%, such as from 5 to 40 at-%, from 10 to 35 at-%, or from 12 to 30 at-%.

The wall of glass may essentially consist of the glass. At least in the surface region, the wall of glass is, in some embodiments, not coated. In some embodiments, at least in the surface region, the wall of glass is not coated with any composition which comprises N.

In some embodiments, in the surface region the wall surface further has a content of 0 in a range from 35 to 70 at-%, such as from 40 to 70 at-%, from 40 to 65 at-%, from 45 to 65 at-%, or from 50 to 65 at-%. The content of 0 is also determinable by X-ray photoelectron spectroscopy.

In some embodiments, in the surface region the wall surface further has content of C of less than 20 at-%, such as less than 15 at-%, or less than 10 at-%. The content of carbon atoms is also determinable by X-ray photoelectron spectroscopy.

In some embodiments, in the surface region the wall surface further has content of alkali metal atoms and alkali metal ions in sum of at least 1 at-%, such as at least 2 at-%, at least 3 at-%, at least 4 at-%, or at least 5 at-%. The content of the alkali metal atoms and the alkali metal ions is also determinable by X-ray photoelectron spectroscopy.

In some embodiments, the wall of glass comprises a wall region, which has the surface region, and in the wall region the wall of glass has a content of chemically bound N which is detectable by a time-of-flight secondary ion mass spectrometry (ToF-SIMS).

In some embodiments, the content of chemically bound N is detectable by the time-of-flight secondary ion mass spectrometry in the form of SiN.

In some embodiments, the wall of glass has a wall thickness, and in the wall region the wall of glass has the content of chemically bound N throughout a functionalizing depth which extends from the wall surface along the wall thickness into the wall of glass. The functionalizing depth may be, for example, less than the wall thickness in the wall region.

In some embodiments, the functionalizing depth is in a range from 5 nm to 10 μm, such as from 5 nm to 5 μm, from 5 nm to 3 μm, from 5 nm to 1 μm, from 5 to 500 nm, from 5 to 300 nm, from 5 to 150 nm, from 5 to 100 nm, from 5 to 50 nm, or from 5 to 20 nm.

In some embodiments, X-ray photoelectron spectroscopy of the surface region shows an Si2p-peak at a binding energy of less than 103.5 eV, such as less than 103.4 eV, less than 103.3 eV, less than 103.2 eV, or less than 103.1 eV.

In some embodiments, X-ray photoelectron spectroscopy of the surface region shows an Si2p-peak at a binding energy in a range from 102.5 to 103.4 eV, such as from 102.5 to 103.3 eV, from 102.5 to 103.2 eV, or from 102.5 to 103.1 eV.

In some embodiments, X-ray photoelectron spectroscopy of the surface region shows an N1s-peak at a binding energy in a range from 397.5 to 405.0 eV, such as from 397.5 to 404.5 eV, from 398.0 to 404.5 eV, from 399.0 to 404.5 eV, from 400.0 to 404.5 eV, from 401.0 to 404.5 eV, from 401.5 to 404.5 eV, from 402.0 to 404.0 eV, from 402.5 to 404.0 eV, or from 403.0 to 404.0 eV.

In some embodiments, the wall surface comprises an interior surface which faces the interior volume, and an exterior surface which faces away from the interior volume. The interior surface, or the exterior surface, or both comprises the surface region. The exterior surface may comprise the surface region. The exterior surface and the interior surface together may comprise the surface region. The surface region may be the exterior surface. The surface region may comprise at least a part of the exterior surface, such as the full exterior surface, or at least a part of the interior surface, such as the full interior surface, or both. The surface region may form the full wall surface. The surface area may form, for example, at least 10%, such as at least 20%, at least 30%, at least 40%, at least 50%, at least 60%, at least 70%, at least 80%, at least 90%, in each case of the exterior surface, or the full exterior surface. The wall surface may consist of the interior surface and the exterior surface.

In some embodiments, the glass of the wall of glass has a content of alkali metal atoms and alkali metal ions of in sum at least 1 wt.-%, such as at least 2 wt.-%, at least 3 wt.-%, at least 4 wt.-%, or at least 5 wt.-%, in each case based on the weight of the glass. In some embodiments, the content of alkali metal atoms and alkali metal ions is in sum not more than 20 wt.-%, such as not more than 15 wt.-%, in each case based on the weight of the glass.

In some embodiments, the glass of the wall of glass is a borosilicate glass or an aluminosilicate glass or both.

In some embodiments, at least in the surface region the wall surface has a coefficient of dry sliding friction of less than 0.4, such as less than 0.3 or less than 0.2.

In some embodiments, the hollow body has a transmission coefficient for a transmission of light of a wavelength in a range from 400 nm to 2300 nm, such as from 400 to 500 nm or from 430 to 490 nm, through the hollow body via the surface region of more than 0.7, such as more than 0.75, more than 0.8, more than 0.81, more than 0.82, more than 0.83, more than 0.84, or more than 0.85. The preceding transmission coefficient may hold for light of each wavelength in the range from 400 nm to 2300 nm, such as from 400 to 500 nm or from 430 to 490 nm.

In some embodiments, the hollow body has a haze for a transmission of light through the hollow body via the surface region in a range from 5 to 50%, such as from 10 to 40%, from 10 to 35%, from 15 to 25%, or from 15 to 22%. The preceding haze values may refer to a hollow body having an interior volume of about 2 ml and to a transmission of the light through a part of the hollow body which is of the shape of a hollow cylinder.

In some embodiments, the wall surface comprises an exterior surface, which faces away from the interior volume and the surface region forms 5 to 100%, such as 10 to 100%, 20 to 100%, 30 to 100%, 40 to 100%, 50 to 100%, 60 to 100%, 70 to 100%, 80 to 100%, or 90 to 100%, in each case of a surface area of the exterior surface.

In some embodiments, the glass of the wall of glass is of a type selected from the group consisting of a borosilicate glass, such as a type I glass; an aluminosilicate glass; and fused silica; or of a combination of at least two thereof.

In some embodiments, the interior volume is in a range from 0.5 to 100 ml, such as from 1 to 100 ml, from 1 to 50 ml, from 1 to 10 ml, or from 2 to 10 ml.

In some embodiments, the hollow body is a container. The container may be a packaging container for a medical or a pharmaceutical packaging good or both. The container may be, for example, a primary packaging container for a medical or a pharmaceutical packaging good or both. An exemplary pharmaceutical packaging good is a pharmaceutical composition. The container may be suitable for packaging parenterals in accordance with section 3.2.1 of the European Pharmacopoeia, 7th edition from 2011. In some embodiments, the container is one selected from the group consisting of a vial, a syringe, a cartridge, and an ampoule; or a combination of at least two thereof.

In some embodiments, the wall of glass comprises from top to bottom of the hollow body: a top region; a body region, which follows the top region via a shoulder; and a bottom region, which follows the body region via a heel. The body region may be a lateral region of the hollow body. The body region of the wall may form a hollow cylinder. One selected from the group consisting of the body region, the shoulder, the bottom region, and the heel, or a combination of at least two thereof may comprise the surface region. The body region, or the shoulder, or both may comprise the surface region. In a case in which the surface region is comprised by two or more of the preceding regions of the wall, the surface region may be a non-coherent region which consists of two or more distinct part regions. However, the surface region be a coherent region. The top region may comprise, or consist of, from top to bottom of the hollow body a flange and a neck.

In some embodiments, in the body region the wall surface comprises at least a part of the surface region. The surface region may form the wall surface at least in the body region.

In some embodiments, throughout the body region a wall thickness of the wall of glass is in a range from ±0.3 mm, such as ±0.2 mm, ±0.1 mm, or ±0.08 mm, in each case based on a mean value of the wall thickness in the body region.

In some embodiments, throughout the body region a wall thickness of the wall of glass is in a range from 0.2 to 5 mm, such as from 0.4 to 3 mm, from 0.5 to 2 mm, or from 0.6 to 1.5 mm. In some embodiments, throughout the body region a thickness of the layer of glass is in a range from 0.9 to 1.1 mm or in a range from 1.5 to 1.7 mm.

In some embodiments, towards the interior volume the wall of glass is at least partially super-imposed by an alkali metal barrier layer or by a hydrophobic layer or both.

In some embodiments, in the surface region the wall surface further has content of B of at least 0.5 at-%, such as at least 1.0 at-%, at least 1.5 at-%, or at least 1.7 at-%, the content of B being determinable by X-ray photoelectron spectroscopy.

In some embodiments, the interior volume comprises a pharmaceutical composition.

In some exemplary embodiments provided according to the present invention, a process for making an item comprises as process steps:
a) providing a hollow body comprising a wall of glass, the wall of glass at least partially surrounding an interior volume of the hollow body, having a wall surface, which comprises a surface region, and comprises a wall region, which has the surface region; and
b) introducing N at least into the wall region, thereby obtaining a content of N of the wall surface at least in the surface region in a range from 0.3 to 10.0 at-%, the preceding content of N being determinable by an X-ray photoelectron spectroscopy.

Further exemplary embodiments of the process provided according to the present invention are described further herein.

In some embodiments, the content of N is from 0.35 to 10 at-%, such as from 0.4 to 10.0 at-%, from 0.45 to 10.0 at-%, from 0.5 to 10.0 at-%, from 0.55 to 10.0 at-%, from 0.6 to 10.0 at-%, from 0.7 to 10.0 at-%, from 0.8 to 10.0 at-%, from 0.9 to 10.0 at-%, from 1.0 to 10.0 at-%, from 1.0 to 9.0 at-%, from 1.0 to 8.0 at-%, from 1.0 to 7.0 at-%, from 1.0 to 6.0 at-%, from 1.0 to 5.0 at-%, from 1.0 to 4.0 at-%, from 1.0 to 3.0 at-%, or from 1.0 to 2.0 at-%,

In some embodiments, after the process step b), the wall surface further has a content of Si of at least 5 at-%, such as at least 10 at-%, at least 11 at-%, at least 12 at-%, at least 13 at-%, or at least 14 at-%; in each case the preceding content is determinable by X-ray photoelectron spectroscopy. In some embodiments, the hollow body, in particular its wall of glass, more particular the surface region, has the technical features of the previously described hollow body provided according to the present invention. Hence, features which are described in the context of the hollow body are also applicable for the hollow body of the process, in particular after the process step b).

In some embodiments, the wall of glass has a wall thickness, and in the process step b) the N is introduced at least into the wall region from the wall surface up to a functionalizing depth, which extends from the wall surface along the wall thickness into the wall of glass. The functionalizing depth may be less than the wall thickness in the wall region. The functionalizing depth may be, for example, in a range from 5 nm to 10 μm, such as from 5 nm to 5 μm, from 5 nm to 3 μm, from 5 nm to 1 μm, from 5 to 500 nm, from 5 to 300 nm, from 5 to 150 nm, from 5 to 100 nm, from 5 to 50 nm, or 5 to 20 nm.

In some embodiments, the glass of the wall of glass has a glass softening temperature, and in the process step b) the wall of glass has a temperature in K of less than 80%, such as less than 70%, less than 60%, or less than 50%, in each case of the glass softening temperature in K.

In some embodiments, in the process step b) the wall of glass has a temperature which is at least 25 K, such as at least 100 K or at least 140 K, less than its glass softening temperature.

In some embodiments, in the process step b) the wall of glass has a temperature of less than 400° C., such as less than 350° C., less than 300° C., or less than 250° C.

In some embodiments, in the process a plasma is obtained which comprises the N which in the process step b) is introduced at least into the wall region. The plasma may be created prior to the process step b), in the process step b), or in a step which overlaps with the process step b).

In some embodiments, the plasma has a plasma pressure in a range from 0.1 to 1,000 mbar, such as from 0.1 to 100 mbar or from 0.1 to 10 mbar.

In some embodiments, the plasma is obtained from a plasma precursor which comprises nitrogen atoms at a proportion of at least 10 vol.-%, such as at least 15 vol.-%, at least 20 vol.-%, or at least 25 vol.-%, in each case based on the volume of the plasma precursor. The composition may comprise the nitrogen atoms at a proportion in a range from 10 to 100 vol.-%, such as from 20 to 100 vol.-%, from 30 to 100 vol.-%, from 40 to 100 vol.-%, from 50 to 100 vol.-%, from 60 to 100 vol.-%, from 70 to 100 vol.-%, from 80 to 100 vol.-%, or from 90 to 100 vol.-%, in each case based on the volume of the plasma precursor. The composition may comprise nitrogen atoms at a proportion in a range from 10 to 100 vol.-%, such as from 10 to 90 vol.-%, from 10 to 80 vol.-%, from 10 to 70 vol.-%, from 10 to 60 vol.-%, from 10 to 50 vol.-%, from 10 to 40 vol.-%, from 10 to 35 vol.-%, or from 15 to 35 vol.-%, in each case based on the volume of the plasma precursor. The plasma precursor may be a gas. Obtaining the plasma from the plasma precursor may comprise irradiating the plasma precursor with electromagnetic waves, or passing an electric current through the plasma precursor, or both. Therein, electromagnetic waves may be one selected from the group consisting of electromagnetic waves with frequencies in the microwave range, electromagnetic waves at audio frequencies, and electromagnetic waves at low frequencies, or a combination of at least two thereof. An exemplary electromagnetic current is a DC current. An exemplary DC current is driven by one selected from the group consisting of a glow discharge, a corona discharge, and an electric arc, or by a combination of at least two thereof.

In some embodiments, the plasma precursor further comprises hydrogen atoms at a proportion of more than 0 up to 90 vol.-%, such as from 5 to 90 vol.-%, from 10 to 90 vol.-%, from 20 to 90 vol.-%, from 30 to 90 vol.-%, from 40 to 90 vol.-%, from 50 to 90 vol.-%, from 60 to 90 vol.-%, from 70 to 85 vol.-%, or from 70 to 80 vol.-%, in each case based on the volume of the plasma precursor.

In some embodiments, the plasma precursor comprises an N-comprising compound. An exemplary N-comprising compound is one selected from the group consisting of a silazane, ammonia, an amine, a cyanide, and N₂, or a combination of at least two thereof. An exemplary silazane is hexamethyldisilazane (HMDS, with the general formula (HN[Si(CH₃)₃]₂). An exemplary cyanide is hydrogen cyanide (HCN). An exemplary amine is methylamine (CH₅N). The plasma precursor may additionally comprise H₂.

In some embodiments, in the process step b) the wall surface is contacted with the plasma at least across the surface region.

In some embodiments, in the process step b) the contacting with the plasma is conducted for a duration in a range from 1 min to 24 h, such as from 1 min to 20 h, from 1 min to 15 h, from 1 min to 10 h, from 5 min to 10 h, from 10 min to 10 h, from 0.5 to 10 h, or from 1 to 10 h.

In some embodiments, prior to the process step b), or in the process step b), or both the hollow body is positioned in a reaction volume and the plasma precursor flows into the reaction volume at a flow rate in a range from 10 to 1000 sccm per m³ of the reaction volume, such as from 10 to 600 sccm per m³ of the reaction volume, from 10 to 500 sccm per m³ of the reaction volume, from 20 to 400 sccm per m³ of the reaction volume, or from 30 to 300 sccm per m³ of the reaction volume.

In some embodiments, in the process step b) the N is introduced at least into the wall region via an ion implantation. The ion implantation may comprise obtaining N ions from the plasma, such as via applying an electrical field and accelerating the N ions towards at least the surface region.

In some embodiments, prior to the process step b) X-ray photoelectron spectroscopy of the surface region shows an Si2p-peak at a first binding energy, and after the process step b) X-ray photoelectron spectroscopy of the surface region shows an Si2p-peak at a further binding energy, the further binding energy being less, such as by at least 0.1 eV, by at least 0.2 eV, by at least 0.3 eV, by at least 0.4 eV, or by at least 0.5 eV, than the first binding energy.

In some embodiments, prior to the process step b) the process comprises a step of at least partially decreasing a contact angle for wetting with water of the wall surface at least in the surface region by a pre-treatment. The contact angle for wetting with water may be decreased at least at a part of the exterior surface or at least at a part of the interior surface or both, such as across the full exterior surface or across the full interior surface or both. The contact angle for wetting with water may be decreased across the full wall surface by the pre-treatment. Further, the contact angle for wetting with water of the at least part of the wall surface may be decreased to less than 30°, such as less than 20° or less than 10°.

In some embodiments, the pre-treatment is selected from the group consisting of a plasma pre-treatment, a flame pre-treatment, a corona pre-treatment, and a wet chemical pre-treatment; or a combination of at least two thereof. An exemplary plasma pre-treatment comprises contacting the wall surface at least in the surface region with a pre-treatment plasma obtained from an O-comprising pre-treatment plasma precursor, or from a corona discharge, or both. In case of a plasma pre-treatment, the pre-treatment plasma is to be distinguished from the plasma which comprises the N which is introduced into at least the wall region in the process step b).

In some embodiments, prior to, or during the process step b), or both at least the wall region is heated to a temperature in a range from 25° C. to less than 80% of the glass softening temperature in ° C., such as from 30° C. to less than 70% of the glass softening temperature in ° C., from 40° C. to less than 60% of the glass softening temperature in ° C., or from 50° C. to less than 50% of the glass softening temperature in ° C. In some embodiments, prior to, or during the process step b), or both at least the wall region is heated to a temperature in a range from 25 to less than 400° C., such as from 30 to less than 350° C., or from 40 to less than 300° C.

In some embodiments, the item is the previously described hollow body.

In some embodiments, prior to the process step b) the process comprises a step of contacting the wall surface at least in the surface region with a reducing atmosphere. Herein, the reducing atmosphere is an atmosphere which comprises a reaction partner which is capable of undergoing a reducing reaction with the wall surface at least in the surface region. The reducing reaction partner may comprise H⁺ or be capable of donating H⁺. An exemplary reducing atmosphere is a further plasma, referred to herein as pre-treatment plasma. The pre-treatment plasma may be different from the plasma with which the wall surface is contacted in the process step b) at least in the surface region. An exemplary pre-treatment plasma comprises hydrogen ions at a proportion of in a range from 30 to 100 vol.-%, such as from 50 to 100 vol.-% or from 70 to 100 vol.-%, based on the volume of the pre-treatment plasma.

In some embodiments, after the process step b) the wall surface is heated at least partially to at least 200° C., such as at least 250° C., at least 300° C., or at least 320° C. The preceding temperature may be kept constant for a duration of at least 3 min, such as at least 5 min, at least 10 min, at least 30 min, or at least 1 h. The preceding duration may be up to several days, 48 h, or 24 h. In some embodiments, the interior surface or the exterior surface or both, such as the full wall surface, is heated as outlined in the preceding. The preceding heating may be a measure of a depyrogenization step.

In some embodiments, the process step b) comprises adjusting, such as decreasing, a coefficient of dry sliding friction of the wall surface at least in the surface region to less than 0.4.

In some embodiments, in the process step a) the hollow body has a first transmission coefficient for a transmission of light of a wavelength in a range from 400 nm to 2300 nm, such as from 400 to 500 nm or from 430 to 490 nm, through the hollow body via the surface region; after the process step b) the hollow body has a further transmission coefficient for a transmission of light of a wavelength in a range from 400 nm to 2300 nm, such as from 400 to 500 nm or from 430 to 490 nm, through the hollow body via the surface region, a ratio of the first transmission coefficient to the further transmission coefficient being in a range from 0.95 to 1.05, such as from 0.99 to 1.01 or from 0.995 to 1.005. The first and the further transmission coefficients may hold for light of each wavelength in the range from 400 nm to 2300 nm, such as from 400 to 500 nm or from 430 to 490 nm.

In some embodiments, in the process step a) the hollow body has a first haze for a transmission of light through the hollow body via the surface region; after the process step b) the hollow body has a further haze for a transmission of light through the hollow body via the surface region, the further haze being in a range from 95.0 to 105.0%, such as from 99.7 to 100.3%, from 99.8 to 100.2%, from 99.9 to 100.1%, or from 100 to less than 100.1%, in each case of the first haze. The above haze values may refer to a hollow body having an interior volume of about 2 ml and to a transmission of the light through a part of the hollow body which is of the shape of a hollow cylinder.

In some embodiments a hollow body obtainable by the previously described process is provided. The hollow body may show the technical features of the previously described hollow body provided according to the present invention.

In some exemplary embodiments provided according to the present invention, a closed container comprises a wall of glass which at least partially surrounds an interior volume which comprises a pharmaceutical composition. The wall of glass has a wall surface, which comprises a surface region. In the surface region the wall surface has a content of N in a range from 0.3 to 10.0 at-% and at least 5 at-% Si, the preceding contents both being determinable by an X-ray photoelectron spectroscopy.

Further exemplary embodiments of the closer container provided according to the present invention are described further herein.

In some embodiments, the content of N is from 0.35 to 10 at-%, such as from 0.4 to 10.0 at-%, from 0.45 to 10.0 at-%, from 0.5 to 10.0 at-%, from 0.55 to 10.0 at-%, from 0.6 to 10.0 at-%, from 0.7 to 10.0 at-%, from 0.8 to 10.0 at-%, from 0.9 to 10.0 at-%, from 1.0 to 10.0 at-%, from 1.0 to 9.0 at-%, from 1.0 to 8.0 at-%, from 1.0 to 7.0 at-%, from 1.0 to 6.0 at-%, from 1.0 to 5.0 at-%, from 1.0 to 4.0 at-%, from 1.0 to 3.0 at-%, or from 1.0 to 2.0 at-%,

In some embodiments, the content of Si is at least 10 at-%, such as at least 11 at-%, at least 12 at-%, at least 13 at-%, or at least 14 at-%.

The wall of glass of the closed container may be designed as the wall of glass of the previously described hollow body provided according to the present invention. The closed container may show the technical features of the previously described hollow body provided according to the present invention.

In some exemplary embodiments provided according to the present invention, a process comprises as process steps:
A) providing the previously described hollow body provided according to the present invention;
B) inserting a pharmaceutical composition into the interior volume; and
C) closing the hollow body.

The closing in the process step C) may comprise contacting the hollow body with a closure, such as a lid, covering an opening of the hollow body with the closure, and joining the closure to the hollow body. The joining may comprise creating a form-fit of the hollow body, such as of the flange of the hollow body, with the closure. The form-fit may be created via a crimping step. The process may be a process for packaging the pharmaceutical composition.

In some embodiments, prior to the process step B) the process further comprises a step of heating the wall surface at least partially to at least 200° C., such as at least 250° C., at least 300° C., or at least 320° C. The preceding temperature may be kept constant for a duration of at least 3 min, such as at least 5 min, at least 10 min, at least 30 min, or at least 1 h. The preceding duration may be up to several days, 48 h, or 24 h. The interior surface or the exterior surface or both, such as the full wall surface, may be heated as outlined in the preceding. The heating may be a measure of a depyrogenization step.

Exemplary embodiments disclosed herein also provide a closed hollow body obtainable by the previously described process.

In some exemplary embodiments provided according to the present invention, a process comprises as process steps:
A. providing the previously described hollow body, closed container, or closed hollow body provided according to the present invention; and
B. administering the pharmaceutical composition to a patient.

In some exemplary embodiments provided according to the present invention, a use of the hollow body provided according to the present invention is for packaging a pharmaceutical composition. The packaging may comprise inserting the pharmaceutical composition into the interior volume and closing the hollow body.

In some exemplary embodiments provided according to the present invention, a use of a composition comprising N, for introducing the N at least into a wall region of a wall of glass of a container, thereby adjusting a content of N of a wall surface of the wall of glass at least in a surface region of the wall surface to be in a range from 0.3 to 10.0 at-%, the preceding content of N being determinable by X-ray photoelectron spectroscopy; the wall of glass at least partially surrounds an interior volume of the hollow body.

Further exemplary embodiments of the use provided according to the present invention are described further herein.

The content of N may be from 0.35 to 10 at-%, such as from 0.4 to 10.0 at-%, from 0.45 to 10.0 at-%, from 0.5 to 10.0 at-%, from 0.55 to 10.0 at-%, from 0.6 to 10.0 at-%, from 0.7 to 10.0 at-%, from 0.8 to 10.0 at-%, from 0.9 to 10.0 at-%, from 1.0 to 10.0 at-%, from 1.0 to 9.0 at-%, from 1.0 to 8.0 at-%, from 1.0 to 7.0 at-%, from 1.0 to 6.0 at-%, from 1.0 to 5.0 at-%, from 1.0 to 4.0 at-%, from 1.0 to 3.0 at-%, or from 1.0 to 2.0 at-%.

The composition may be configured as the previously described plasma precursor provided according to the present invention. The adjusting may be conducted in accordance with the process provided according to the present invention, particularly in accordance with the process step b). Further, the wall of glass may be configured as the wall of glass of the previously described hollow body provided according to the present invention.

In some embodiments, a plasma is obtained from the composition and contacted with the wall surface at least across the surface region.

In some embodiments, a plasma comprising the N, is obtained from the composition and the N is introduced at least into a wall region via an ion implantation.

In some embodiments, the glass of the wall of glass has a glass softening temperature; while the N is introduced at least into a wall region the wall of glass has a temperature of less than 80%, such as less than 70%, less than 60%, or less than 50%, in each case of the glass softening temperature. Alternatively, while the N is introduced at least into a wall region the wall of glass has a temperature as specified in the context of the process step b) of the previously described process provided according to the present invention.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a schematic depiction of an exemplary embodiment of a hollow body provided according to the present invention;

FIG. 2 illustrates a schematic depiction of an exemplary embodiment of a closed hollow body provided according to the present invention;

FIG. 3 illustrates a flow chart of an exemplary embodiment of a process provided according to the present invention for the preparation of a hollow body;

FIG. 4 illustrates a flow chart of an exemplary embodiment of a process provided according to the present invention for packaging a pharmaceutical composition;

FIG. 5 illustrates a flow chart of an exemplary embodiment of a process provided according to the present invention for treating a patient;

FIG. 6 illustrates results of measurements of the functionalizing depth of vials of the examples 1 to 3; and

FIG. 7 illustrates results of measurements of the transmission coefficient of vials according to the examples 1 to 4 and the comparative example 1.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Elemental Contents of the Wall of Glass

According to the present invention, the wall of glass is characterized at least in the surface region of the wall surface by contents of different chemical elements in at-%. The corresponding elemental analysis is conducted via an X-ray photoelectron spectroscopy as described herein. In other words, the contents of the different chemical elements in at-% are determinable by X-ray photoelectron spectroscopy (“XPS”). The chemical elements are referred to by their abbreviations as provided in the periodic table of elements. The elemental contents determined (or determinable) by XPS provided herein refer to the wall of glass itself, not to any optional coating or functionalization which may superimpose the wall of glass. Thus, the content of N is a content in the wall of glass at least in the wall region. This content is determined/determinable by conducting XPS at the surface region which is a region of the surface of the wall of glass itself, i.e. a glass surface. The N of the content of N may be chemically bound in the wall of glass via SiN-bonds.

Surface Region

Each surface region may be a coherent region. In other words, in some embodiments the surface regions is not a discontinuous region. Herein, a discontinuous region is a region which comprises multiple mutually spaced regions.

Hollow Body

The hollow body provided according to the present invention may have any size or shape which the skilled person deems appropriate in the context of the present invention. In some embodiments, the head region of the hollow body comprises an opening, which allows for inserting a pharmaceutical composition into the interior volume of the hollow body. In that case, the wall of glass surrounds the interior volume of the hollow body only partially. The hollow body may be a glass body or a glass container. The wall of glass may be of a one-piece design. The wall of glass of such a glass body or a glass container may be made by blow molding a glass melt; or by preparing a tube of a glass, such as in the form of a hollow cylinder, forming the bottom of the hollow body from one end of the tube, thereby closing the tube at this end, and forming the head region of the hollow body from the opposite end of the tube. The wall of glass may be transparent.

As used herein, the interior volume represents the full volume of the interior of the hollow body. This volume may be determined by filling the interior of the hollow body with water up to the brim and measuring the volume of the amount of water which the interior can take up to the brim. Hence, the interior volume as used herein is not a nominal volume as it is often referred to in the technical field of pharmacy. This nominal volume may, for example, be less than the interior volume by a factor of about 0.5.

Glass

The wall of glass comprises a glass, and may essentially consist of the glass. This glass may be any type of glass and may have any composition which the skilled person deems suitable in the context of the present invention. The glass may be, for example, suitable for pharmaceutical packaging. The glass may be, for example, of type I in accordance with the definitions of glass types in section 3.2.1 of the European Pharmacopoeia, 7^{th} edition from 2011. Additionally or alternatively, the glass may be selected from the group consisting of a borosilicate glass, an aluminosilicate glass, and fused silica; or a combination of at least two thereof. As used herein, an aluminosilicate glass is a glass which has a content of Al₂O₃ of more than 8 wt.-%, such as more than 9 wt.-% or in a range from 9 to 20 wt.-%, in each case based on the total weight of the glass. An exemplary aluminosilicate glass has a content of B₂O₃ of less than 8 wt.-%, such as at maximum 7 wt.-% in a range from 0 to 7 wt.-%, in each case based on the total weight of the glass. As used herein, a borosilicate glass is a glass which has a content of B₂O₃ of at least 1 wt.-%, such as at least 2 wt.-%, at least 3 wt.-%, at least 4 wt.-%, at least 5 wt.-%, or in a range from 5 to 15 wt.-%, in each case based on the total weight of the glass. An exemplary borosilicate glass has a content of Al₂O₃ of less than 7.5 wt.-%, such as less than 6.5 wt.-% or in a range from 0 to 5.5 wt.-%, in each case based on the total weight of the glass. In some embodiments, the borosilicate glass has a content of Al₂O₃ in a range from 3 to 7.5 wt.-%, such as in a range from 4 to 6 wt.-%, in each case based on the total weight of the glass.

A glass which is further exemplary according to the present invention is essentially free from B. Therein, the wording “essentially free from B” refers to glasses which are free from B which has been added to the glass composition by purpose. This means that B may still be present as an impurity, but at a proportion of, for example, not more than 0.1 wt.-%, such as not more than 0.05 wt.-%, in each case based on the weight of the glass.

Depyrogenization

In some embodiments of the process, after the process step b) the wall surface is heated at least partially to at least 200° C., such as at least 250° C., at least 300° C., or at least 320° C. This heating may be a measure of a depyrogenization step. In the technical field of pharmacy, depyrogenization is a step of decreasing an amount of pyrogenic germs on a surface, such as via a heat-treatment. Therein, the amount of pyrogenic germs on the surface may be decreased as much as possible, such as by at least 80%, at least 90%, at least 95%, at least 99%, at least 99.5%, or by 100%, in each case based on an amount of the pyrogenic germs on the surface prior to the depyrogenization.

Pharmaceutical Composition

In the context of the present invention, every pharmaceutical composition which the skilled person deems suitable comes into consideration. A pharmaceutical composition is a composition comprising at least one active ingredient. An exemplary active ingredient is a vaccine. The pharmaceutical composition may be fluid or solid or both. An exemplary solid composition is granular such as a powder, a multitude of tablets or a multitude of capsules. A further exemplary pharmaceutical composition is a parenteral, i.e. a composition which is intended to be administered via the parenteral route, which may be any route which is not enteral. Parenteral administration can be performed by injection, e.g. using a needle (usually a hypodermic needle) and a syringe, or by the insertion of an indwelling catheter.

Wall

Herein, the hollow body comprises a wall of glass. The hollow body may comprise further layers of materials which superimpose the wall of glass fully or partially on one or both sides of the wall of glass. In any case, however, the wall surface with the surface region refers to the wall of glass, i.e. these are surfaces of the wall of glass itself, hence glass surfaces. If the hollow body comprises one or more layers which are superimposed to the wall of glass, these layers are joined to one another and to the wall of glass. Two layers are joined to one another when their adhesion to one another goes beyond Van-der-Waals attraction forces. Unless otherwise indicated, layers may follow one another in a direction of a thickness of the wall of glass indirectly, in other words with one or at least two intermediate components, or directly, in other words without any intermediate component. This is particularly the case with the formulation wherein one layer superimposes another. Further, if a component is superimposed onto a layer or a surface, this component may be contacted with that layer or surface or it may not be contacted with that layer or surface, but be indirectly overlaid onto that layer or surface with another component (e.g. a layer) in-between.

Alkali Metal Barrier Layer and Hydrophobic Layer

In some embodiments, the wall of glass of the hollow body is superimposed by an alkali metal barrier layer or by a hydrophobic layer or both, in each case towards the interior volume of the hollow body, such as across at least a part of the interior surface, or the full interior surface of the wall of glass. The alkali metal barrier layer may consist of any material or any combination of materials which the skilled person deems suitable for providing a barrier action against migration of an alkali metal ion, such as against any alkali metal ion. The alkali metal barrier layer may be of a multilayer structure. In some embodiments, the alkali metal barrier layer comprises SiO₂, such as a layer of SiO₂. Further, the hydrophobic layer may consist of any material or any combination of materials which provides a layer surface towards the interior volume which has a contact angle for wetting with water of more than 90°. The hydrophobic layer may allow for the formation of a well-defined cake upon freeze-drying, in particular in terms of a shape of the cake. An exemplary hydrophobic layer comprises a compound of the general formula SiOₓC_{y}H_{z}, such as a layer of this compound. Therein, x is a number which is less than 1, such as in a range from 0.6 to 0.9 or from 0.7 to 0.8; y is a number in a range from 1.2 to 3.3, such as from 1.5 to 2.5; and z is a number as well.

### Measurement Methods

The following measurement methods are to be used in the context of the present invention. Unless otherwise specified, the measurements have to be carried out at an ambient temperature of 23° C., an ambient air pressure of 100 kPa (0.986 atm) and a relative atmospheric humidity of 50%.

Contact Angle for Wetting with Water

The contact angle of a surface for wetting with water is determined in accordance with the standard DIN 55660, parts 1 and 2. The contact angle is determined using the static method. Deviating from the standard, the measurement is conducted at curved surfaces as the wall of the hollow body is usually curved. Further, the measurements are conducted at 22 to 25° C. ambient temperature and 20 to 35% relative atmospheric humidity. A Drop Shape Analyzer—DSA30S from Krüss GmbH is applied for the measurements. Uncertainty of the measurement increases for contact angles below 10°.

Wall Thickness and Tolerance of Wall Thickness

The wall thickness and deviations from the mean value of the wall thickness (tolerance) are determined in accordance with the following standards for the respective type of hollow body:

DIN ISO 8362-1 for vials,
DIN ISO 9187-1 for ampoules,
DIN ISO 11040-4 for syringes,
DIN ISO 13926-1 for cylindrical cartridges, and
DIN ISO 11040-1 for dental cartridges.

Transmission Coefficient

Herein, the transmission coefficients are defined as T=Iₜᵣₐₙₛ/I₀, wherein I₀ is the intensity of the light which is incident at a right angle on an incidence region of the surface region and Iₜᵣₐₙₛ is the intensity of the light which leaves the hollow body on a side of the hollow body which is opposite to the incidence region. Hence, T refers to light which transmits the empty hollow body completely, i.e. one time through the wall into the empty interior volume and from there a second time through the wall out of the interior volume. Hence, the light transmits through two curved sections of the wall of the hollow body. The transmission coefficient is determined in accordance with the standard ISO 15368:2001(E), wherein an area of measurement of the dimensions 3 mm×4 mm is used. Further, the light is incident on the hollow body at a right angle to the vertical extension of the exterior surface of the hollow body. In some embodiments, the transmission coefficients herein refer to a hollow body of the type 2R according to DIN/ISO 8362 and to a transmission of the light through a part of the hollow body which is of the shape of a hollow cylinder. In case the transmission coefficient for a transmission of light via an unfunctionalized surface of a hollow body (herein also referred to as first transmission coefficient) is to be determined and the hollow body does not have any unfunctionalized surface which is suitable for the measurement, the functionalization (e.g. particles) is removed first and then the transmission coefficient via the surface from which the functionalization has been removed is determined.

Haze

The haze is a measure for the light scattering properties of a transparent sample, such as a glass sample. The value of the haze represents the fraction of light which has been transmitted through the sample, here the empty container, and which is scattered out of a certain spatial angle around the optical axis. Thus, the haze quantifies material defects in the sample which negatively affect transparency. Herein, the haze is determined according to the standard ASTM D 1033. In accordance with this standard, 4 spectra are measured and for each of them the transmission coefficient is calculated. The haze value in % is calculated from these coefficients of transmission. A Thermo Scientific Evolution 600 spectrometer with integrating sphere and the software OptLab-SPX are applied for the measurements. In order to allow for measuring the diffusive transmission, the sample is positioned in front of the entrance of the integrating sphere. The reflection opening is left empty such that only the transmitted and scattered fraction of the incident light is detected. The fraction of the transmitted light which is not sufficiently scattered is not detected. Further measurements pertain to detection of the scattered light in the sphere (without sample) and to the overall transmission of the sample (reflection opening closed). All the measurement results are normalized to the overall transmission of the sphere without sample which is implemented as obligatory baseline correction in the software. Herein, the haze refers to light which transmits the hollow body completely, i.e. one time through the wall into the interior volume and from there a second time through the wall out of the interior volume. Hence, the light transmits through two curved sections of the wall of the hollow body. Further, the light is incident on the hollow body at a right angle to the vertical extension of the exterior surface of the hollow body. The hollow body may be a vial of the type 2R according to DIN/ISO 8362 and the transmission is conducted through a part of the hollow body which is of the shape of a hollow cylinder. In case the haze for a transmission of light via an unfunctionalized surface of a hollow body (herein also referred to as first haze) is to be determined and the hollow body does not have any unfunctionalized surface which is suitable for the measurement, the functionalization (e.g. particles) is removed first and then the haze via the surface from which the functionalization has been removed is determined.

Scratch Test and Coefficient of Dry Sliding Friction

An MCT MikroCombiTester (MCT S/N 01-04488) from CSM Instruments is applied for the scratch test and for measuring the coefficient of dry friction. As the friction partner, a hollow body which is identical to the hollow body to be tested, including any coatings or functionalizations, is used. Further, in the test same surfaces are scratched/slide against each other. The friction partner is hold in position by a special mount above the hollow body to be tested. Here, the friction partner and the hollow body to be tested incline an angle of 90° in a top view. For both measurements, the hollow body to be tested is moved forwards, thereby scratching over the surface of the friction partner at a well-defined normal force (test force). For both tests, the hollow body to be measured is moved forwards underneath the friction partner at a velocity of 10 mm/min over a test length of 15 mm. In case of the scratch test, the test force is progressively increased from 0 to 30 N (load rate 19.99 N/min) across the test length. Afterwards, the scratched surface is checked with a microscope at a magnification of 5 times. In case of measuring the coefficient of dry sliding friction, a constant normal force of 0.5 N is applied. The lateral friction force is measured using the friction measuring table. The coefficient of dry friction is determined from the measured curves as the ratio of friction force to normal force (test force), wherein only values after the initial 0.2 mm up to the full test length of 15 mm are considered, in order to minimize the influence of the static friction.

Softening Temperature

The softening temperature of a glass is defined as the temperature of the glass at which the glass has a viscosity η in dPa·s (=Poise) such that log₁₀(η)=7.6. The softening temperature is determined in accordance with ISO 7884-3.

Washing Process

A HAMO LS 2000 washing machine is applied for the washing procedure. The HAMO LS 2000 is connected to the purified water supply. Further, the following devices are used.

cage 1: 144 with 4 mm nozzles
cage 2: 252 with 4 mm nozzles
drying cabinet from Heraeus (adjustable up to 300° C.)

The tap is opened. Then the machine is started via the main switch. After conducting an internal check, the washing machine shows to be ready on the display. Program 47 is a standard cleaning-program which operates with the following parameters:

pre-washing without heating for 2 min
washing at 40° C. for 6 min
pre-rinsing without heating for 5 min
rinsing without heating for 10 min
end-rinsing at without heating for 10 min
drying without heating for 5 min

The holder for the vials in the cages 1 and 2 have to be adjusted considering the size of the vials in order to obtain a distance of the nozzle of about 1.5 cm. The vials to be washed are placed on the nozzles with the head first. Subsequently, the stainless steel mesh is fixed on the cage. The cage is oriented to the left and pushed into the machine. Then the machine is closed. Program 47 (GLAS040102) is selected and then the HAMO is started via START. After the program has finished (1 h), the cages are taken out and the vials are placed with their opening facing downwards in drying cages. A convection drying cabinet with ambient air filter is applied for the drying. The drying cabinet is adjusted to 300° C. The vials are placed into the drying cabinet for 20 min. After the vials have cooled down, they are sorted into appropriate boxes.

X-Ray Photoelectron Spectroscopy (XPS)

Prior to the XPS-measurement, the hollow body to be studied is washed. In case of a vial as the hollow body, the above washing process is applied, otherwise a suitable analogue washing process is applied. The XPS-studies are conducted on the washed hollow body. Any contamination of the hollow body after the washing process is to be avoided. The X-ray photoelectron spectroscopy measurements are performed using a PHI Quantera S×M system. For data acquisition, the software SmartSoft-XPS V3.6.2.7 is used. For the XPS-measurement, the excitation is carried out with a monochromatic Al-kα source (1486.6 eV/15 kV) with 200 μm spot size. The electrons are detected under an angle to the normal of 45°. The built-in charge compensation system is employed during analysis, using electrons and low-energy argon ions to prevent charging of the sample. The pressure inside the measurement chamber is 1.5·10⁻⁶ Pa during measurement, and pass energies of 55 eV (high resolution spectra) and 140 eV (survey spectra) are used. For data processing the software MultiPak V9.5.0.8 is used. A so-called Shirley background is applied to fit the background of all spectra. For quantification the sensitivity factors as implemented in the software MultiPak (based on C. D. Wagner et al. in Surface and Interfaces Analysis, 3 (1981) 211) and the analyzer transmission function are applied. All spectra are referenced to the C is-peak of hydrocarbon at 285.0 eV binding energy and controlled by means of the well-known photoelectron peaks of metallic Cu, Ag, and Au.

Time-of-Flight Secondary Ion Mass Spectrometry (ToF-SIMS)

Prior to the ToF-SIMS-measurement, the hollow body to be studied is washed. In case of a vial as the hollow body, the above washing process is applied, otherwise a suitable analogue washing process is applied. The ToF-SIMS-studies are conducted on the washed hollow body. Any contamination of the hollow body after the washing process is to be avoided. ToF-SIMS depth profiles are performed using a TOF-SIMS IV-100, company ION-TOF GmbH equipped with 25 keV Ga+ primary ions. The analysis is performed on an area of 50×50 μm² with a primary ion current of approximately 1.0 pA. The sputter treatment is performed in alternating mode by a Cs+ sputter ion gun on an area of 300×300 μm² with an energy of 0.5 keV and a sputter current of approximately 40 nA. For charge compensation an electron flood gun is used. Negatively charged ions are analyzed and—for better standardisation—the detected intensities are normalised to the Si— ion intensities. For data processing the software SurfaceLab 6.7 is used.

Exemplary embodiments provided according to the present invention are set out in more detail below, with the examples and drawings not denoting any restriction on the present invention. Furthermore, unless otherwise indicated, the drawings are not to scale.

### Examples 1 to 3 (Provided According to the Present Invention)

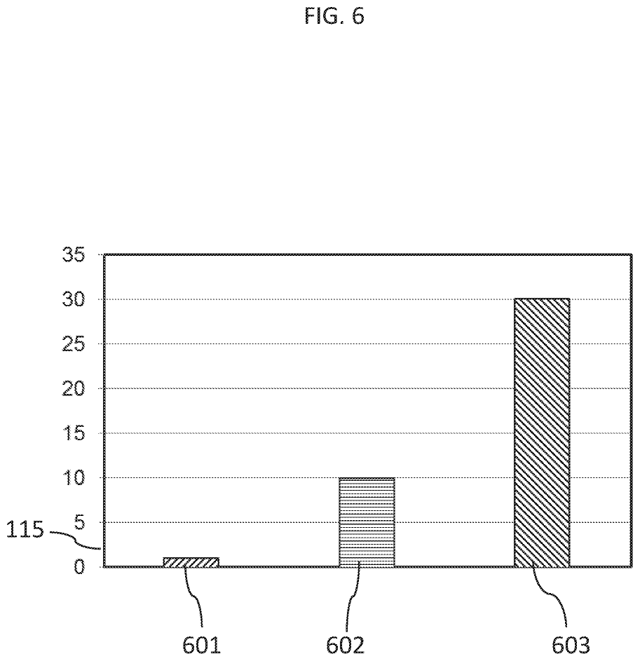

For each of the examples 1 to 3, commercially available glass vials of the type “Vial 2.00 ml Fiolax clear” from Schott AG, which are further of the type 2R according to DIN/ISO 8362, are provided. These vials are washed as described above in the measurement methods section. In each example, the vials are treated with a plasma which is created from a gas of NH₃ (100 vol-%). The vials are placed in a reactor of the type Diener Nano (PlasmaCoat Express) which is commercially available from Diener Electronics. The reactor has a volume of 17 dm³ and consists of a quartz glass tube. The plasma precursor gas is introduced into the reactor at the flow rate provided in table 1 below. In the reactor, a plasma is created from the gas via radio frequency (RF) at 13.56 MHz at a power of 600 W. The created plasma contains nitrogen atoms and ions and contacts the vials in the reactor across their full glass surface. For each of the examples, the plasma treatment is conducted for the duration of treatment provided in the Table 1 below. Thereby, N is implanted into the glass walls of the vials. The depth, measured from the outer surface of the vial, up to which N is implanted into the glass wall is shown for vials of the examples 1 to 3 in FIG. 6. After the plasma treatment, the RF-generator is shut off and the vials are taken from the reactor.

TABLE 1
Parameters of the plasma treatment
according to the examples 1 to 3

| | Flow rate of the plasma precursor gas | Duration of plasma |
|---|---|---|
| | [sccm per m³ reaction volume] | treatment [h] |
| Example 1 | 300 | 6 |
| Example 2 | 300 | 8 |
| Example 3 | 30 | 8 |

### Comparative Example 1 (not According to the Present Invention)

A commercially available glass vial of the type “Vial 2.00 ml Fiolax clear” from Schott AG, which of the type 2R according to DIN/ISO 8362, is provided as a reference. The surface of this vial does not have any coating or functionalization. Prior to any measurement, the vial is washed.

### Comparative Example 2 (not According to the Present Invention)

A commercially available glass vial of the type “Vial 2.00 ml Fiolax clear” from Schott AG, which is further of the type 2R according to DIN/ISO 8362, and which has been washed as described below is coated on its exterior surface with MED10-6670 from NuSiL. The coated vial is dried for 10 min at 350° C. in an oven. No plasma treatment is applied.

Evaluation

XPS-measurements are conducted as described above on the exterior surfaces of the vials of the examples 1 to 3 and the comparative example 1. The vials of the comparative example 2 have glass bodies which are identical to the reference vials of the comparative example 1, however, with a coating on top. Therefore, the elemental contents of the glass bodies of the vials of comparative example 2 can be assumed to be identical to those of the comparative example 1. The elemental contents as determined are presented in the Table 2 below.

TABLE 2
Elemental contents as determined by the XPS-measurements
conducted on the vials of the examples 1 to 3 and the
reference vial of the comparative example 1

| | Content of [at-%] | | | | | |
|---|---|---|---|---|---|---|
| | | | | | alkali | |
| | N | Si | O | C | metals | B |
| Example 1 | 0.4 | 22.1 | 53.4 | 12.5 | 3.3 | 1.9 |
| Example 2 | 0.6 | 21.1 | 53.7 | 3.9 | 6.3 | 1.8 |
| Example 3 | 1.45 | 14.4 | 55.6 | 8.4 | 0 | 0.6 |
| Comparative | 0.25 | 24.0 | 61.8 | 7.4 | 2.85 | 1.8 |
| Example 1 | | | | | | |

The detection threshold of the XPS-measurements for N is at about 0.2 at-%. Accordingly, essentially no N is measured in case of the comparative example 1. This finding is in line with scientific reports (G. Iucci et al., Solid State Sciences 12, 1861-1865 (2010); G. Kaklamani et al., Materials Letters, 111, 225-229 (2013); D. Ditter et al., European Journal of Pharmaceutics and Biopharmaceutics 125 (2018) 58-67) according to which essentially no N is measured via XPS at uncontaminated glass surfaces of the prior art, in particular at the outer glass surfaces of pharmaceutical containers of the prior art.

XPS is a surface sensitive measurement technique, which makes it a good fit for characterizing a low friction layer on the exterior surface of the vial body. Other measurement techniques are more directed to the depth of the sample and analyze multiple layers, which makes it difficult to characterize the low friction layer that is the exposed and may be thin.

Further, the binding energies reported in Table 3 below are determined via XPS as described in the measurement methods section.

TABLE 3
Binding energies as determined by the XPS-measurements
conducted on the vials of the examples 1 to 3 and the
reference vial of the comparative example 1

| | Si2p binding | N1s binding |
|---|---|---|
| | energy [eV] | energy [eV] |
| Example 1 | 103.3 | 402.5 |
| Example 2 | 103.1 | 402.5 |
| Example 3 | 102.9 | 403.0 |
| Comparative | 103.2 | 402.0 |
| example 1 | | |

Further, for each of the examples 1 to 3 and the comparative examples 1 and 2, the coefficient of dry sliding friction is determined on the exterior surface of the vial body in accordance with the above measurement method. The results are shown in Table 4.

TABLE 4
Coefficients of dry sliding friction of the exterior surfaces of
the vials of the examples 1 to 3 and the comparative examples

| | Coefficient of dry |
|---|---|
| | sliding friction |
| Example 1 | 0.36 |
| Example 2 | 0.37 |
| Example 3 | 0.18 |
| Comparative example 1 | 0.5 |
| Comparative example 2 | 0.28 |

Further, 10,000 of the vials of each example and comparative example, respectively, are processed on a standard pharmaceutical filling line and thus, filled with an influenza vaccine. Table 5 below shows an evaluation of the vials regarding their tendency to be damaged or even break on the filling line. Here, ++ means that no or only very few vials are being damaged or broken, + means that few vials are being damaged or broken, − means that damages to vials and broken vials occur more often than for +, −− means that damages to vials and broken vials occur more often than for −.

TABLE 5
Comparison of the tendency of the glass vials to be damaged
on the filling line and the maximum temperature of the
vials during the above described treatment for the examples
1 to 3 and the comparative examples 1 and 2

| | Low tendency to damages |
|---|---|
| | on filling line |
| Example 1 | + |
| Example 2 | + |
| Example 3 | ++ |
| Comparative example 1 | −− |
| Comparative example 2 | + |

It can be seen from the results presented in the above Tables 4 and 5 that vials of the examples 1 to 3 are superior to the untreated reference vials of comparative example 1. Further, the inventive examples 1 to 3 include no coating of the glass vials, whereas the vials of comparative example 2 are provided with a silicone coating. Silicone, however, is often not completely and securely bonded to the glass surface of the vial. Therefore, the silicone tends to creep across the glass surface. This bears a risk of contamination of the inner surface of the vial. Such contamination is inacceptable for pharmaceutical containers. Even more, contamination with an organic composition such as the silicone coating of the comparative example 2 is particularly undesirable. Further, vials having a silicone coating cannot be labelled as easy as vials without such a coating. If a standard adhesive is used, the label often does not sufficiently adhere to the coated vial. If, however, a special adhesive is used which provides better adhesion of the label to the coated vial, the special adhesive partly softens the silicone coating which then tends to creep even more. In consequence, the risk of contamination is increased even more. It follows that a silicone coating such as the one applied in the comparative example 2 is particularly undesirable to be applied to pharmaceutical containers.

Further, vials which have been filled with a pharmaceutical composition and closed typically have to be inspected, in particular for pharmaceutically relevant particles. This is usually done by optical methods which call for a high transparency and low haze of the vials. Here, prior to filling them, vials of the examples and comparative examples are studied for their optical characteristics which may influence an optical inspection of the vials. The increase of the haze by the above described treatments and the transmission coefficient of the vials are determined in accordance with the above measurement methods. The results of the haze measurements are provided in the Table 6 below. The increase of the haze by the treatment of vial with respect to the untreated vial which corresponds to comparative example 1 is shown.

TABLE 6
Increase of the haze of the vials of the
examples and the comparative examples

| | Increase of |
|---|---|
| | haze [%] |
| Example 1 | <0.3 |
| Example 2 | <0.3 |
| Example 3 | <0.3 |
| Comparative example 1 | / |
| Comparative example 2 | 6 |

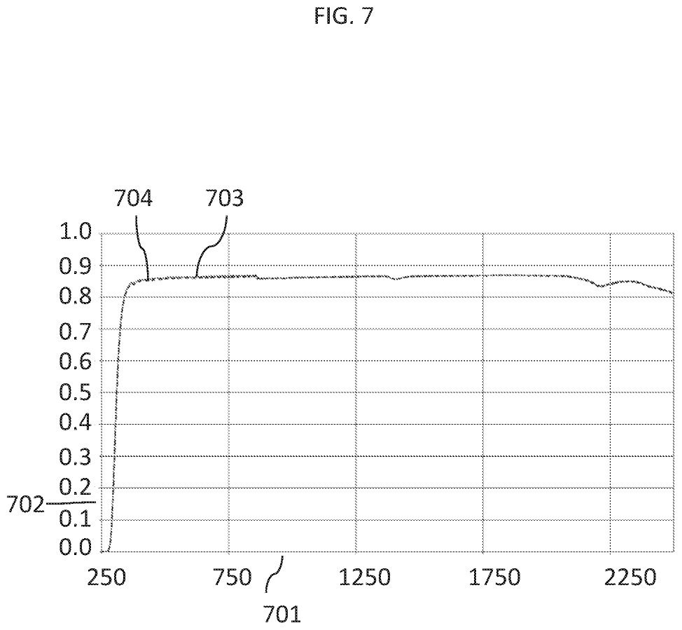

Results of the transmission coefficient measurements on vials of the examples 1 to 3 and the reference vial of the comparative example 1 are shown in FIG. 7. From this, it can be seen that the plasma treatment according to the examples 1 to 3 does not significantly deteriorate the transmission coefficient in the studied spectral range. Therefore, the vials of the inventive examples are very well suited for being optically inspected.

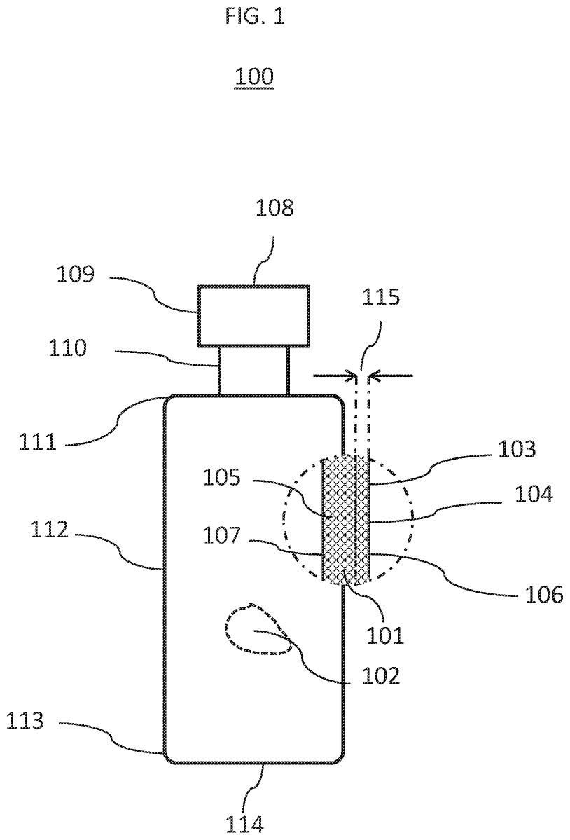

FIG. 1 shows a schematic depiction of a hollow body 100 provided according to the present invention. The hollow body 100 comprises a wall of glass 101 which partially surrounds an interior volume 102 of the hollow body 100. The wall of glass 101 surrounds the interior volume 102 only partially in that the hollow body 100 comprises an opening 108 which allows for filling the hollow body 100 with a pharmaceutical composition 201 (not shown). Further, the wall of glass 101 has a wall surface 103, which consists of an interior surface 107 which faces the interior volume 102, and an exterior surface 106 which faces away from the interior volume 102. The wall of glass 101 forms from top to bottom in the FIG. 1: a top region of the hollow body 100, which consists of a flange 109 and a neck 110; a body region 112, which follows the top region via a shoulder 111; and a bottom region 114, which follows the body region 112 via a heel 113. Here, the body region 112 is a lateral region of the hollow body 100 in form of a hollow cylinder. The hollow body 100 of FIG. 1 is a vial which has been treated according to the example 1 above. The exterior surface 106 forms a surface region 104 of the wall surface 103 according to the nomenclature used herein. Thus, the exterior surface 106 has the contents of N, Si, 0 and C measured/measurable by XPS as reported above. Here, the N has been implanted into the wall of glass 101 by the process described above for example 1 from the exterior surface 106 up to a functionalizing depth 115 into the wall of glass 101. It can be seen from FIG. 6 that the functionalizing depth 115 is 10 nm.

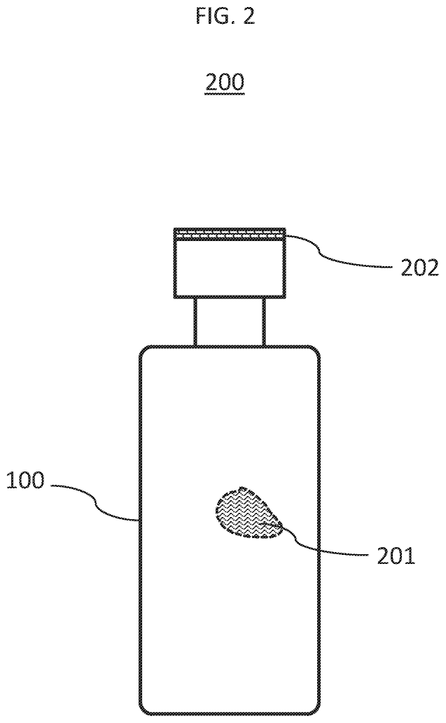

FIG. 2 shows a schematic depiction of a closed hollow body 200 provided according to the present invention. This closed hollow body 200 is a vial which has been obtained by filling the hollow body 100 of FIG. 1 with a pharmaceutical composition 201 and closing the opening 108 with a lid 202 via a crimping step. Here, the pharmaceutical composition 201 is a vaccine.

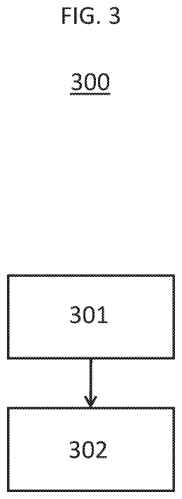

FIG. 3 shows a flow chart of a process 300 provided according to the present invention for the preparation of a hollow body 100. The process 300 comprises a process step a) 301 in which a commercially available glass vial of the type “Vial 2.00 ml Fiolax clear” from Schott AG which of the type 2R according to DIN/ISO 8362 is provided. In a process step b) 302, N is introduced into the wall of glass 101 by a plasma treatment of the exterior surface 106 as described in detail above in the context of the example 1 according to the present invention. The hollow body 100 of FIG. 1 is obtained through the process 300.

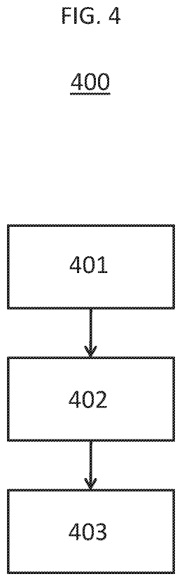

FIG. 4 shows a flow chart of a process 400 provided according to the present invention for packaging a pharmaceutical composition 201. In a process step A) 401, the hollow body 100 according to FIG. 1 is provided. In a process step B) 402, a pharmaceutical composition 201 is filled into the interior volume 102 of the hollow body 100, and in a process step C) 403 the opening 108 of the hollow body 100 is closed, thereby obtaining the closed hollow body 200 of FIG. 2.

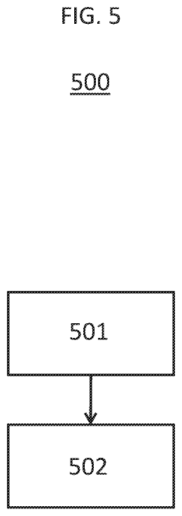

FIG. 5 shows a flow chart of a process 500 provided according to the present invention for treating a patient. This process 500 comprises the process steps of: A. 501 providing the closed hollow body 200 of FIG. 2, opening the closed hollow body 200 by penetrating the lid 202 with a needle of a syringe, filling the syringe with the vaccine; and B. 502 administering the vaccine subcutaneously to a patient using the syringe.

FIG. 6 shows results of measurements of the functionalizing depth 115 in nm of vials of the examples 1 to 3. The bar 601 denotes the results for the example 1, 602 the results for example 2, and 603 the results for example 3. The results presented in FIG. 6 have been determined by ToF-SIMS as described above in the measurement methods section.

FIG. 7 shows results of measurements of the transmission coefficient 702 of vials according to the examples 1 to 4 and the comparative example 1 over the wavelength in nm 701. In the diagram, 703 denotes the measurement results for the examples 1 to 4 and 704 the results for the comparative example 1. All these results are so close to each other that the corresponding graphs appear essentially as one in the diagram. The dip at 865 nm is a measurement artefact.

Exemplary embodiments provided according to the present invention provide a glass container for pharmaceutical packaging which allows for an increase of a production rate of a filling line. Also provided is a glass container for pharmaceutical packaging which allows for an increase of a processing speed of a filling line, or for a reduction of disruptions of a filling line, or both. Also provided is a glass container for pharmaceutical packaging which shows a reduced tendency to being damaged or even broken while being processed on a filling line. Also provided is a container that is further suitable for an easy and reliable optical inspection after having been filled. Also provided is a container that does not show an increased tendency to being contaminated, for example in a pharmaceutically relevant manner. The preceding contamination refers, in particular, to the presence of a contaminating organic composition in the container interior. In this context, the container may comprise no multilayer coating, or no coating at all, which could be a potential source of contamination. Also provided is a glass container for pharmaceutical packaging that can be labelled easily. Also provided is a container that is further suitable for a post-treatment, for example a sterilization treatment, which may be effected as a high-temperature-treatment—in particular a depyrogenisation; or a washing process; or a low-temperature-treatment—in particular a freeze drying. Also provided is a process for producing one of the above advantageous glass containers for pharmaceutical packaging, the process being less complex than known processes.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

100 hollow body provided according to the present invention
101 wall of glass
102 interior volume
103 wall surface
104 surface region
105 wall region
106 exterior surface
107 interior surface
108 opening
109 flange
110 neck
111 shoulder
112 body region
113 heel
114 bottom region
115 functionalizing depth
200 closed container provided according to the present invention/closed hollow body provided according to the present invention
201 pharmaceutical composition
202 lid
300 process provided according to the present invention for the preparation of a hollow body
301 process step a)
302 process step b)
400 process provided according to the present invention for packaging a pharmaceutical composition
401 process step A)
402 process step B)
403 process step C)
500 process provided according to the present invention for treating a patient
501 process step A.
502 process step B.
601 measurement results for comparative example 1
602 measurement results for example 1
603 measurement results for example 3
701 wavelength in nm
702 transmission coefficient
703 measurement results for examples 1 to 4
704 measurement results for comparative example 1

What is claimed is:

1. A hollow body, comprising:
a wall of glass which at least partially surrounds an interior volume of the hollow body, the wall of glass having a wall surface which comprises a surface region, at least in the surface region the wall surface has a content of N in a range from 0.3 to 10.0 at-% and a content of at least 5 at-% Si, the contents of Ni and S being determinable by X-ray photoelectron spectroscopy.

2. The hollow body of claim 1, wherein in the surface region the wall surface further has a content of 0 in a range from 35 to 70 at-%, the content of 0 being determinable by X-ray photoelectron spectroscopy.

3. The hollow body of claim 1, wherein in the surface region the wall surface further has a content of less than 20 at-% of C, the content of C being determinable by X-ray photoelectron spectroscopy.

4. The hollow body of claim 1, wherein in the surface region the wall surface further has a content of alkali metal atoms and alkali metal ions in sum of at least 1 at-%, the content of alkali metal atoms and alkali metal ions being determinable by X-ray photoelectron spectroscopy.

5. The hollow body of claim 1, wherein in the surface region the wall surface further has a content of B of at least 0.5 at-%, the content of B being determinable by X-ray photoelectron spectroscopy.

6. The hollow body of claim 1, wherein X-ray photoelectron spectroscopy of the surface region shows an N1s-peak at a binding energy in a range from 397.5 to 405.0 eV.

7. The hollow body of claim 1, wherein the surface region of the wall surface has a coefficient of dry sliding friction of less than 0.4.

8. The hollow body of claim 1, wherein the hollow body lacks a coating applied to the wall of glass.

9. The hollow body of claim 8, wherein the hollow body is suitable for holding a pharmaceutical composition in accordance with Section 3.2.1 of the European Pharmacopoeia, 7th edition.

10. The hollow body of claim 1, wherein the wall of glass has a wall thickness and in the wall region the wall of glass has a content of chemically bound N throughout a functionalizing depth which extends from the wall surface along the wall thickness into the wall of glass.

11. The hollow body of claim 10, wherein the functionalizing depth is less than the wall thickness in the wall region.

12. The hollow body of claim 10, wherein the functionalizing depth is in a range from 5 nm to 10 μm.

13. The hollow body of claim 1, wherein the hollow body has a transmission coefficient for a transmission of light of a wavelength in a range from 400 nm to 2300 nm through the hollow body via the surface region of more than 0.7.

14. The hollow body of claim 1, wherein the hollow body has a haze for a transmission of light through the hollow body via surface region in a range from 5% to 50%.

15. The hollow body of claim 1, wherein the hollow body is a container and further comprises a closure closing the container and a pharmaceutical composition placed in the interior volume.

16. The hollow body of claim 1, wherein the wall of glass comprises at least one of a borosilicate glass, an aluminosilicate glass, and fused silica.

17. The hollow body of claim 1, wherein the wall of glass comprises from top to bottom of the hollow body:
a top region;
a body region, which follows the top region via a shoulder; and
a bottom region, which follows the body region via a heel.

18. The hollow body of claim 1, wherein, towards the interior volume, the wall of glass is at least partially super-imposed by at least one of an alkali metal barrier layer or a hydrophobic layer.

19. A process for making an item, comprising as process steps:
a) providing a hollow body comprising a wall of glass, the wall of glass at least partially surrounding an interior volume of the hollow body, having a wall surface which comprises a surface region, and comprising a wall region which has the surface region; and
b) introducing N at least into the wall region, thereby obtaining a content of N of the wall surface at least in the surface region in a range from 0.3 to 10.0 at-%, wherein the preceding content of N is determined by an X-ray photoelectron spectroscopy.

20. A process, comprising as process steps:
A) providing a hollow body, the hollow body comprising a wall of glass which at least partially surrounds an interior volume of the hollow body, the wall of glass having a wall surface which comprises a surface region, at least in the surface region the wall surface has a content of N in a range from 0.3 to 10.0 at-% and a content of at least 5 at-% Si, the contents of Ni and S being determinable by X-ray photoelectron spectroscopy;
B) inserting a pharmaceutical composition into the interior volume; and
C) closing the hollow body.
